(19) United States
(12) Patent Application Publication
(10) Pub. No.: US 2005/0147834 A1
(43) Pub. Date: Jul. 7, 2005

(54) Multi-layered materials for producing packaging

(76) Inventors: Bernd Bruchmann, Freinsheim (DE); Joelle Bedat, Strasbourg (FR); Jurgen Kaczun, Niederkirchen (DE); Peter Poganiuch, Neustadt (DE); Eva Wagner, Darmstadt (DE); Jean-Francois Stumbe, Strasbourg (FR)

Correspondence Address: NIXON & VANDERHYE, PC, 1100 N GLEBE ROAD, 8TH FLOOR, ARLINGTON, VA, 22201-4714, US

(21) Appl. No.: 10/510,438

(22) PCT Filed: Apr. 25, 2003
(86) PCT No.: PCT/EP03/04296

(30) Foreign Application Priority Data
Apr. 30, 2002 (DE) 102 19 509.9

(51) Int. Cl. B32B 15/08

(52) U.S. Cl. 428/458; 428/480

(57) ABSTRACT

Multilayer materials for producing packaging, comprising at least 2 films and a layer printed with a printing ink, the printing ink comprising a hyperbranched polyester containing functional groups; a printing ink comprising a polyester containing functional groups; and the use of said printing ink for producing multilayer materials.

The invention relates to multilayer materials for producing packaging comprising at least two films and also a layer which is printed with a packaging printing ink, said packaging printing ink comprising a hyperbranched polyester containing functional groups. The invention further relates to a packaging printing ink which comprises a hyperbranched polyester containing functional groups, and to the use of said printing ink for producing multilayer materials.

Multilayer materials for producing packaging, especially food packaging, are known. As examples mention may be made of EP-A 695 329, EP-A 707 956, EP 802 045, EP-A 1 008 442 or EP-A 1 162 060. Multilayer materials of this kind are composed of two or more polymer films, polyolefin films for example, metal foils or metallized polymer films, which are joined to one another, for example, by lamination and with the aid of suitable laminating adhesives. The films (incl. foils) may each be monolayer or multilayer films produced by coextrusion. The laminates may further comprise other functional layers, examples being odor barrier layers or water vapor barriers.

Multilayer materials for producing packaging are normally printed or coated. The printing ink may be applied to the surface of the multilayer material or else may be between two films. Printing varnishes are either applied to the print substrate as a primer or applied to the print substrate after printing, as a protective coating. Printing varnishes contain no colorant, but apart from that are generally similar in their composition to printing inks.

The requirements imposed on printing varnishes and printing inks which are suitable for producing multilayer packaging materials are diverse. When printing onto nonabsorbent print substrates such as polymer films or metal foils, the printing ink cannot of course penetrate into the substrate, but instead leaves a dried film on the substrate after the solvent has evaporated. Printing inks for such substrates must therefore have very good film-forming properties and also especially good adhesive strength, so that the print film does not detach from the substrate under mechanical stress. Since laminates frequently contain films which differ from one another chemically, examples being polar polyamide or PET films and apolar polyolefin films, suitable printing inks are also required to adhere equally well to different kinds of substrates.

Printing inks comprising conventional binders lack sufficient strength of adhesion to numerous print substrates, and so it is necessary to add adhesion promoters such as certain silanes or titanates. By way of example, reference may be made here to U.S. Pat. No. 5,646,200. Even with the addition of adhesion promoters, however, the adhesion is not satisfactory on all print substrates, and so the films of multilayer composite materials may part from one another. Since multilayer composite materials are frequently used in the food sector, there is a further, general desire as far as possible to avoid low molecular mass constituents in printing ink formulas. This is desirable anyway on economic grounds.

Dendrimers, arborols, starburst polymers, and hyperbranched polymers are designations for polymeric structures which feature a branched structure with numerous branching sites and a high functionality. Dendrimers are molecularly uniform macromolecules having a highly symmetrical structure. However, they can only be synthesized with great complexity in syntheses comprising a large number of stages, and as a consequence are available only in small amounts and at very great cost.

In contrast, hyperbranched polymers are nonuniform both molecularly and structurally. They contain arms which differ in length and branching. Hyperbranched polymers can be synthesized using what are known as ABₓ monomers. These monomers contain two different functional groups, A and B, which are able to react with one another to form a link. The functional group A is present only once per molecule and the functional group B is present two or more times. The reaction of said ABₓ monomers with one another produces uncrosslinked polymers with regularly arranged branching sites. The polymers contain almost exclusively B groups at the chain ends. Further details are disclosed, for example, in J. M. S.—Rev. Macromol. Chem. Phys., C37(3), 555-579 (1997).

Both hyperbranched and dendrimeric polyesters are known in principle; by way of example, OH-containing polyesters from WO 93/17060.

It is also known to modify hyperbranched polyesters with acrylate groups, for example, by reacting the polyesters with glycidyl(meth)acrylate as disclosed by WO 00/77070, WO 00/59982, WO 96/07688 or WO 96/13558. Polyesters modified in this way can be used in UV-curable systems, examples being UV-curable varnishes.

WO 96/13558 discloses radiation-curable compositions comprising ethylenically unsaturated monomers and hyperbranched modified polyester polyols which contain ethylenically unsaturated terminal groups. Also disclosed is the use of such radiation-curable compositions for producing coatings such as automotive finishes, furniture coatings or radiation-curable printing inks.

WO 00/77070 discloses the modification of a hyperbranched polyester polyol with a mixture of (meth)acrylic acid and also a further, different carboxylic acid such as lauric acid, for example. Proposed, moreover, is the use of polyesters modified in this way for UV-curable printing inks.

UV-curable printing inks contain no solvents but can be printed only on specially equipped printing machines and so give rise to additional capital costs. Moreover, in the case of UV inks, the adhesion of the ink film to important print substrates such as polyester, polyamide or polypropylene is frequently unsatisfactory, so that many users give preference to packaging printing inks.

Printing inks comprising hyperbranched polyesters are disclosed in our as-yet unpublished application PCT/EP/01/12520. Multilayer materials for producing packaging which comprise specific hyperbranched polyesters, however, have not yet been disclosed.

It is an object of the invention to provide multilayer materials for producing packaging, which exhibit improved adhesion between the individual films. A particular object is to provide multilayer materials which comprise polar films and exhibit improved adhesion between the individual films. A further object is to provide packaging printing inks and printing varnishes suitable for this purpose which can be cured without UV radiation, which also contain as small as possible an amount of low molecular mass components and which can be prepared inexpensively.

We have found that this object is achieved by multilayer materials for producing packaging, comprising at least
one film 1 of a polymeric material,
one print layer obtainable by printing or coating with a packaging printing ink,
one further film 2,
   the packaging printing ink comprising as binder at least one hyperbranched polyester containing functional groups selected from the group consisting of OH, COOH and COOR groups.

The invention secondly provides a packaging printing ink for flexographic and/or gravure printing which comprises at least one solvent or a mixture of different solvents, at least one colorant, at least one polymeric binder, and, optionally, additives as well, at least one of the polymeric binders comprising a hyperbranched polyester containing functional groups selected from the group consisting of OH, COOH and COOR groups.

The invention further provides for the use of said packaging printing ink for printing polymer films or metal foils and for producing multilayer materials.

The invention thirdly provides printing varnishes which comprise at least one solvent or a mixture of different solvents, at least one polymeric binder, and, optionally, additives as well, at least one of the polymeric binders being a hyperbranched polyester containing functional groups selected from OH, COOH and COOR groups. It also provides for their use for priming, as a protective coating, and for producing multilayer materials.

Through the use of packaging printing inks and printing varnishes with binders comprising hyperbranched polyesters containing OH, COOH and COOR groups, surprisingly, multilayer materials featuring outstanding adhesion between the individual layers are obtained. The addition of adhesion promoters is no longer necessary. Particularly surprising and unexpected, even for the skilled worker, is that the results obtained without adhesion promoters can in fact be better than when adhesion promoters are added. On polar films in particular it was possible to improve the adhesion substantially.

Details of the invention are set out below.

The film 1 for the multilayer material is composed of a polymeric material. Films suitable for packaging materials are published, for example, in Ullmann's Encyclopedia of Industrial Chemistry, 6^{th} Edt., 2000, Electronic Release. They include, for example, polyolefin films such as films of polyethylene, polypropylene or poly(4-methyl-1-pentene) or polystyrene. Polyethylene films may be films of HDPE, LDPE or LLDPE. They may be copolymers such as, for example, films of ethylene-vinyl acetate copolymers, ethylene-acrylic acid copolymers or styrene/butadiene copolymers. It is also possible to use films of PVC or polycarbonates.

Moreover, films of polar materials may be used, examples being cellophane films, polyester films, such as those of polyethylene terephthalate, polybutylene terephthalate or polyethylene naphthalate, for example, or polyamide films, such as films of PA 6, PA 12, PA 6/66, PA 6/12 or PA 11, for example.

Film 1 is preferably a film of polyethylene, polypropylene, polystyrene, polyester or polyamide, with very particular preference being given to PET, PEN, and polyamide films.

Film 1 may be a monolayer film. Alternatively, it may be a multilayer film. Multilayer films are preferably produced by coextrusion. The layers may be composed of chemically identical, similar or different polymers. For example, a polyvinyl alcohol layer may be embedded between two polyolefin films, or LLDPE combined with LDPE. The term “multilayer films” also embraces laminates of polymer films and metal foils, especially aluminum foils.

The films may also be coated. Examples that may be mentioned here include metallized films, especially films vapor coated with Al, or films (vapor) coated with SiO₂.

For film 2 it is possible to use polymer films, including metallized polymer films, or metal foils. Suitable polymer films include in particular the materials disclosed for film 1. As metal foils use is made in particular of aluminum foils, although it is also possible, for example, for these foils to be tin foils, copper foils or gold foils.

Particularly preferred multilayer materials comprise at least one polar film in combination with an apolar film. Examples that may be mentioned include laminates of polyamide films or polyester films with polyolefin films, especially polyethylene or polypropylene films. Further preference is given to multilayer materials of polyamide and polyester films or to laminates containing in each case only polyamide or only polyester films.

The multilayer material of the invention further comprises at least print layer which is obtainable by printing or coating at least one of the films with a packaging printing ink.

The printed layer may be on the outside of the multilayer material. Preferably, however, the print layer is between the two films, i.e., embedded in the laminate. The print layer may lie directly on one of the films or there may be one or more other layers between the film and the print layer. The print layer is preferably printed directly either onto film 1 or onto film 2.

The multilayer material may also comprise two or more print layers. With preference, all of the print layers include a hyperbranched polyester containing the functional groups defined at the outset. The minimum requirement, however, is that at least one of the print layers contains said polyester. The print layers may be printed over one another. For example, first a primer, with a white color, for example, may be printed onto a film, followed by a second layer with a single- or multicolor decoration. Alternatively, the primer can be printed onto one film and the decoration onto the other film, or else the primer onto one side and the decoration onto the other side of the same film.

Of course, a multilayer laminate may also include further films in addition to films 1 and 2. The sequence of the films in the laminate is determined by the skilled worker in accordance with the desired properties and the intended use of the multilayer material.

The multilayer material may also comprise additional layers with which in each case particular properties can be achieved. Mention may be made here in particular of adhesive layers, which can be used to join some or all of the layers to one another. Further, it is possible to incorporate additional barrier layers. By way of example, polyvinyl alcohol layers or ethylene-polyvinyl alcohol layers may be incorporated as water vapor barriers. It is also possible to instal odor or aroma barriers. Suitable materials for this purpose are disclosed, for example, in EP-A 707 956 or EP-A 802 045.

The multilayer material may also include layers of printing varnishes, for the purpose, for example, of priming the films or as a protective coating. For this purpose it is possible on the one hand to use conventional printing varnishes. With particular advantage, however, the printing varnishes used are those comprising as binder at least one hyperbranched polyester containing functional groups selected from the group consisting of OH, COOH and COOR groups.

The print layers in the multilayer material are obtainable by printing or coating the films with an appropriate packaging printing ink. Printing is carried out preferably by means of flexographic or gravure methods, although screenprinting can be used in special cases.

The term “packaging printing inks” or “printing inks for packaging” for the purposes of this invention are meant solvent-containing printing inks for flexographic and/or gravure printing which cure by evaporation of the solvent. The term “printing inks for packaging” is both self-explanatory and restrictive. Printing inks for packaging are fast-drying printing inks of low viscosity. Accordingly, they contain relatively low-boiling solvents. Their boiling point is generally not more than 140° C. Screenprinting inks are formulated in much the same way as flexographic or gravure inks but are adjusted to a slightly higher viscosity and normally contain solvents with somewhat higher boiling points. UV-curing printing inks are not embraced by the term “printing inks for packaging” for the purposes of this invention.

In accordance with the invention, the printing ink comprises as binder a hyperbranched polyester containing functional groups selected from the group consisting of OH, COOH and COOR groups. The term “binder” as well is self-explanatory and at the same time restrictive. Binders are one of the principal constituents of printing inks and are responsible for the actual formation of a film. They provide for the anchoring of pigments and fillers in the ink film and for adhesion to the substrate, and are used in the amount necessary to achieve this effect.

The present invention is performed with hyperbranched polyesters in the actual sense, i.e., molecularly and structurally nonuniform polyesters.

The hyperbranched polyesters contain functional groups comprising one or more selected from the group consisting of OH, COOH, and COOR groups.

The radical R in the esterified carboxyl group preferably comprises groups having from 1 to 60 carbon atoms. The groups may also contain heteroatoms or further substituents. Examples of R include C₁-C₈ alkyl radicals, such as methyl, ethyl, propyl, isopropyl, n-butyl, i-butyl, t-butyl, hexyl, octyl radicals, for example, or C₆-C₁₂ aryl or arylalkyl radicals such as benzyl radicals, for example. Preference extends to radicals which contain oxygen atoms in the chain and have the formula —(CHR′—CHR″O)ₙH, n customarily being a natural number from 1-20 and R′ and R″ independently of one another being alternatively H or a methyl or ethyl group.

The COOR group may already be present in the monomeric units for the polymer; alternatively, it can be generated by subsequent functionalization of a COOH group or of a derivative thereof.

The functional groups are essentially terminal groups, although the functional groups may also be arranged pendantly.

With particular preference, the hyperbranched polyester used in accordance with the invention contains both OH and COOH groups.

The polyesters used can be characterized conventionally by their OH number and their acid number. Preference is given to using hyperbranched polyesters which have an acid number of from 1 to 200 mg KOH/g and also an OH number of from 50 to 500 mg KOH/g, although the invention is not restricted to such.

The molar mass is chosen by the skilled worker in accordance with the type of application that is intended. Products which have proven appropriate are those having a weight-average M_{w} of from 1 000 to 60 000 g/mol, preferably from 1 500 to 50 000 g/mol, and with particular preference from 2 500 to 35 000 g/mol.

The uniformity of the hyperbranched polyesters may be indicated conventionally through the ratio M_{w}/Mₙ. M_{w}/Mₙ is generally from 1.2 to 40, preferably from 1.5 to 30, and with very particular preference from 2.0 to 15.

The synthesis of the hyperbranched polyesters may preferably take place as depicted below, without the invention being thereby restricted to the use of the polyesters synthesized by this preparation method.

In the case of the preferred synthesis the reaction solutions reacted comprise
(a) one or more dicarboxylic acids or one or more derivatives thereof with one or more alcohols having a functionality of at least three,
(b) or one or more tricarboxylic acids or higher polycarboxylic acids or one or more derivatives thereof with one or more diols,
(c) or one or more tricarboxylic acids or higher polycarboxylic acids or one or more derivatives thereof with one or alcohols having a functionality of at least three,
(d) or one or more dihydroxy or polyhydroxycarboxylic acids,
(e) or one or more hydroxydicarboxylic or hydroxypolycarboxylic acids,
   or mixtures of at least two of the above reaction solutions.

The dicarboxylic acids which can be reacted in reaction solutions according to variant (a) include, for example, azelaic acid, succinic acid, glutaric acid, adipic acid, pimelic acid, sebacic acid, dodecane-α,ω-dicarboxylic acid, phthalic acid, isophthalic acid or terephthalic acid, it also being possible for the dicarboxylic acids to be substituted.

It is additionally possible to use mixtures of two or more of the aforementioned representatives. The dicarboxylic acids can be used either as such or in the form of derivatives. Derivatives are preferably monoesters or diesters, in which case the radicals R of the one or two COOR groups may independently of one another comprise, preferably, groups having 1-60 carbon atoms. The groups R may also contain heteroatoms or further substituents. By way of example, R comprises C₁-C₈ alkyl radicals, such as methyl, ethyl, propyl, isopropyl, n-butyl, i-butyl, t-butyl, hexyl radicals, for example, or C₆-C₁₂ aryl or arylalkyl radicals such as benzyl radicals, for example. Preference extends to radicals which contain oxygen atoms in the chain and have the formula —(CHR′—CHR″O)ₙH, n customarily being a natural number from 1-20 and R′ and R″ independently of one another being alternatively H or a methyl or ethyl group.

Particular preference is given to using azelaic acid, succinic acid, glutaric acid, adipic acid, phthalic acid, isophthalic acid, terephthalic acid or the monomethyl or dimethyl esters thereof. Very particular preference is given to using adipic acid.

As alcohols with a functionality of at least three it is possible, for example, to use the following: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols such as, for example, mesoerythritol, threitol, sorbitol, mannitol or mixtures of the above alcohols having a functionality of at least three. Preference is given to using glycerol, trimethylolpropane, trimethylolethane or pentaerythritol.

Examples of tricarboxylic or polycarboxylic acids which can be used in reaction solutions according to variant (b) include 1,2,4-benzenetricarboxylic acid, 1,3,5-benzenetricarboxylic acid, 1,2,4,5-benzenetetracarboxylic acid, and mellitic acid.

The tricarboxylic or polycarboxylic acids may be used either as such or else in the form of derivatives, in which case the derivatives are preferably monoesters or polyesters as defined above.

As diols for reaction solutions according to variant (b) of the present invention use is made, for example, of ethylene glycol, propane-1,2-diol, propane-1,3-diol, butane-1,2-diol, butane-1,3-diol, butane-1,4-diol, pentane-1,4-diol, pentane-1,5-diol, pentane-2,3-diol, pentane-2,4-diol, hexane-1,2-diol, hexane-1,6-diol, hexane-2,5-diol, heptane-1,2-diol 1,7-heptanediol, 1,8-octanediol, 1,2-octanediol, 1,9-nonanediol, 1,10-decanediol, 1,2-decanediol, 1,12-dodecanediol, 1,2-dodecanediol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representatives of the above compounds, n being an integer and n=4. Preference is given to ethylene glycol, propane-1,2-diol, and also diethylene glycol, triethylene glycol, dipropylene glycol and tripropylene glycol.

Reaction solutions which can be reacted according to variant (c) contain, for example, one or more triols and one or more tetracarboxylic acids or one or more derivatives thereof. According to variant (c) it is also possible to react one or more tricarboxylic acids or one or more derivatives thereof with one or more tetrafunctional alcohol. The reaction of a triol with a tricarboxylic acid or derivatives is preferably successful when the hydroxyl groups or the carboxyl groups differ greatly from one another in reactivity.

The molar ratio of hydroxyl groups to carboxyl groups in the case of variants (a) to (c) is from 3:1 to 0.3:1, preferably from 2:1 to 0.5:1, in particular from 1.5:1 to 0.75:1.

Reaction solutions which can be reacted according to variant (d) contain one or more dihydroxy- or polyhydroxycarboxylic acids which contain at least 2 hydroxyl groups per molecule, examples being dimethylolpropionic acid, dimethylolbutyric acid, tartaric acid, 3,4-dihydroxyhydrocinnamic acid, 2,3-dihydroxybenzoic acid, 2,4-dihydroxybenzoic acid, 2,5-dihydroxybenzoic acid, 3,4-dihydroxybenzoic acid and 2,6-dihydroxybenzoic acid or mixtures thereof.

Reaction solutions which can be reacted according to variant (e) contain one or more hydroxydicarboxylic or hydroxypolycarboxylic acids, examples being tartaric acid, citric acid, mallic acid, 4-hydroxyphthalic acid, 2-hydroxyterephthalic acid or mixtures thereof.

The dihydroxy- or polyhydroxycarboxylic acids and hydroxydicarboxylic or hydroxypolycarboxylic acids from variants (d) and (e) can be used either as such or else in the form of derivatives, the derivatives preferably being esters as defined above.

It is also possible to react mixtures of at least two of the above reaction solutions of variants (a) to (e).

In the simplest case the reaction solutions consist only of the mixtures of the components which are to be reacted with one another. With preference the reaction solutions also include solvents, suitable esterification or transesterification catalysts, and also, where appropriate, further additives.

It is preferred to operate in the presence of a water-removing agent as additive, which is added at the beginning of the reaction. Suitable examples include weakly acidic silica gels, weakly acidic aluminum oxides, molecular sieves, especially molecular sieve 4 Å, MgSO₄ and Na₂SO₄. The use of strongly acidic silica gels is likewise conceivable. It is also possible to add further water-removing agent during the reaction or to replace water-removing agent by fresh water-removing agent.

As esterification catalysts it is possible, for example, in a known manner, to add acids, such as H₂SO₄, for example. Esterification catalysts are also available commercially, for example, under the name Fascat® (Elf Atochem).

In one particular embodiment the esterification catalyst is an enzyme. Preference is given to the use of lipases and esterases. A particularly suitable example is Candida antarctica lipase B. The enzyme is available commercially, for example, from Novozymes Biotech Inc., Denmark.

The enzyme is preferably employed in immobilized form, on silica gel or Lewatit®, for example. Methods of immobilizing enzymes are known per se, for example, from Kurt Faber, “Biotransformations in organic chemistry”, 3rd edition 1997, Springer Verlag, section 3.2 “Immobilization” pages 345-356. Immobilized enzymes are available commercially, for example, from Novozymes Biotech Inc., Denmark. The amount of enzyme used is usually from 1 to 20% by weight, in particular 10-15% by weight, based on the mass of the starting materials employed overall.

Other variants of the enzymatic synthesis are disclosed in our as-yet unpublished German application DE 101 63 163.4.

The polymerization takes place customarily by heating at temperatures from 50° C. to 200°. When using enzymes, 100° C. ought not to be exceeded.

The polymerization is preferably conducted in the presence of a solvent. Suitable examples include hydrocarbons such as paraffins or aromatics. Particularly suitable paraffins are n-heptane and cyclohexane. Particularly suitable aromatics are toluene, ortho-xylene, meta-xylene, para-xylene, xylene isomer mixture, ethylbenzene, chlorobenzene and ortho- and meta-dichlorobenzene. The following are also especially suitable: ethers such as dioxane or tetrahydrofuran, for example, and ketones such as methyl ethyl ketone and methyl isobutyl ketone, for example. The amount of solvent added is customarily at least 5% by weight, based on the mass of the starting materials used that are to be reacted, preferably at least 50% by weight, and with particular preference at least 100% by weight. Amounts of more than 10 000% by weight of solvent are unwanted, since at markedly lower concentrations there is a marked dropoff in the rate of reaction, leading to uneconomically long reaction times.

After the end of reaction the highly functional hyperbranched polyesters can be isolated, for example, by removal of the catalyst by filtration and concentraton of the filtrate, said concentration customarily being conducted under reduced pressure. Other highly suitable methods of working up the reaction mixture are precipitation following the addition of water, with subsequent washing and drying.

Hyperbranched polyesters particularly suitable for performing the present invention are obtained from adipic acid and also glycerol and/or trimethylolpropane.

For the purposes of the present invention, the hyperbranched polyesters may also be used as a mixture with other binders, provided that the mixture does not cause any unwanted effects, such as instances of precipitation, for example. Examples of further binders for the printing ink of the invention include polyvinylbutyral, nitrocellulose, polyamides, polyacrylates or polyacrylate copolymers. The combination of the hyperbranched polyesters with nitrocellulose has proven particularly advantageous. The total amount of all binders in the printing ink of the invention is normally 5-35% by weight, preferably 6-30% by weight, and with particular preference 10-25% by weight, based on the sum of all the constituents. The ratio of the amounts of hyperbranched polyesters to the total amount of all binders is normally 30/100 to 1, preferably 40/100 to 1, although the amount of hyperbranched polyesters should not fall below generally 3% by weight, preferably 4% by weight, and with particular preference 5% by weight with respect to the sum of all of the constituents of the printing ink.

Either a single solvent or else a mixture of two or more solvents can be used. Solvents suitable in principle are the customary solvents for printing inks for packaging. Particularly suitable solvents for the printing ink of the invention are alcohols such as ethanol, 1-propanol, 2-propanol, ethylene glycol, propylene glycol, diethylene glycol, substituted alcohols such as ethoxypropanol, esters such as ethyl acetate, isopropyl acetate, n-propyl or n-butyl acetate. A further solvent suitable in principle is water. Particular preference as solvents is given to ethanol and to mixtures composed predominantly of ethanol. Among the solvents which are possible in principle, the skilled worker will make an appropriate selection in accordance with the solubility properties of the polyester and the desired properties of the printing ink. It is normal to use from 40 to 80% by weight of solvent, based on the sum of all the constituents of the printing ink.

As colorants it is possible to use the customary coloring substances, especially customary pigments. Examples are inorganic pigments such as titanium dioxide pigments or iron oxide pigments, interference pigments, carbon blacks, metal powders such as particularly aluminum, brass or copper powders, and also organic pigments such as azo, phthalocyanine or isoindoline igments. It is of course also possible to use mixtures of different dyes or pigments, and also soluble organic dyes. It is normal to use from 5 to 25% by weight of colorant, based on the sum of all the constituents.

The packaging printing ink of the invention may optionally comprise further additives and auxiliaries. Examples of additives and auxiliaries are fillers such as calcium carbonate, aluminum oxide hydrate or aluminum and/or magnesium silicate. Waxes increase the abrasion resistance and serve to raise the lubricity. Examples are, in particular, polyethylene waxes, oxidized polyethylene waxes, petroleum waxes or ceresin waxes. Fatty acid amides can be used to increase the surface smoothness. Plasticizers serve to increase the elasticity of the dried film. Examples are phthalates such as dibutyl phthalate, diisobutyl phthalate or dioctyl phthalate, citric esters or esters of adipic acid. For dispersing the pigments it is possible to use dispersing auxiliaries. With the printing ink of the invention it is possible with advantage to forego the use of adhesion promoters, although this fact is not intended to rule out the use of adhesion promoters. The total amount of all additives and auxiliaries does not normally exceed 20% by weight of the sum of all the constituents of the printing ink, and is preferably 0-10% by weight.

The packaging printing ink of the invention can be prepared in a manner which is known in principle, by intensive mixing and/or dispersing of the constituents in customary apparatus such as dissolvers, stirred ballmills or a triple-roll mill, for example. First of all, advantageously, a concentrated pigment dispersion is prepared with a portion of the components and with a portion of the solvent, and is subsequently processed further with additional constituents and additional solvent to give the finished printing ink.

The printing varnishes of the invention naturally do not contain colorants, but apart from that contain the same constituents as the printing inks outlined above. The amounts of the other components are increased accordingly.

The print layer obtainable with the packaging printing ink has essentially the same composition as the printing ink, except that some or all of the solvent and any volatiles present undergo evaporation.

The print layers exhibit outstanding adhesion to both polar and apolar substrates. They are particularly suitable for producing multilayer materials with polyamide or polyester films.

Multilayer materials comprising these films and the printing ink of the invention exhibit especially good adhesion between the layers.

The invention is described in more detail by the following examples:

Preparation of the Hyperbranched Polyesters

For the invention the following hyperbranched polyesters were used:

### EXAMPLE 1

Synthesis Using Conventional Catalyst

In a 2 l reactor provided with stirrer, reflux condenser, and water separator, 702 g of adipic acid, 537 g of trimethylolpropane and 2.4 g of Fascat® 4201 (E-coat, Elf Atochem) in 200 g of toluene are heated at from 125 to 130° C. and the water of reaction is removed. After a reaction time of 11 and removal of the toluene on a rotary evaporator under reduced pressure, a colorless viscous polyester was. The analytical data are summarized in Table 1.

### EXAMPLE 2

Synthesis without Catalyst

In a 2 l reactor equipped with stirrer and descending condenser, 175 g of adipic acid and 92 g of trimethylolpropane are heated at from 150 to 170° C. and the water of reaction formed is distilled off during the reaction. After a reaction time of 4 h a colorless viscous polyester is obtained.

The analytical data are assembled in Table 1.

### EXAMPLE 3

Synthesis Using Enzyme Catalyst

In a 1 l round-bottomed flask, 105.2 g of adipic acid and 55.2 g of glycerol are dissolved in 300 g of anhydrous dioxane. Then 30 g of molecular sieve (0.4 nm) and 20 g of immobilized lipase from Candida Antarctica B (Novozym® 435, Novozymes Biotech Inc.) are added and the reaction mixture is stirred at 70° C. for 99 h. After cooling to room temperature, the immobilized enzyme is filtered off and solvent is stripped off on a rotary evaporator under reduced pressure. The product is a colorless, viscous polyester.

The analytical data are assembled in Table 1

TABLE 1
Summary of the results

| | Molecular weight | | | | |
|---|---|---|---|---|---|
| | from GPC data | | | | |
| | (PS calibration, | | | | |
| | mobile phase THF) | | | Acid number | OH number |
| No. | M_{w} | Mₙ | M_{w}/Mₙ | [mg KOH/g] | [mg KOH/g] |
| 1 | 16 170 | 1 590 | 10.2 | 77 | 190 |
| 2 | 4 000 | 1 540 | 2.6 | 89 | 228 |
| 3 | 30 050 | 3 180 | 9.5 | 42 | 154 |

Preparation of Printing Inks

A number of flexographic printing inks were prepared by intensively mixing the following components:

| | |
|---|---|
| 70.0 | Pigment preparation (BASF Drucksysteme) |
| 6.0 | Hyperbranched polyester |
| 8.0 | Nitrocellulose (Wolf) |
| 1.0 | Oleamide (Croda) |
| 0.5 | PE waxes (BASF AG) |
| 2.0 | Dibutyl phthalate (Brenntag) |
| 10.5 | Ethanol |
| 2.0 | Titanium chelate adhesion promoter (Du Pont) |

A second series was carried out using the same components but leaving out the adhesion promoter. For comparative purposes, moreover, flexographic printing inks were prepared using conventional PU binders (PUR 7313 (BASF)), which are normally used for this purpose in the prior art. The formulations are summarized in table 2:

TABLE 2
Composition of the test printing inks

| No. | Binder | Adhesion promoter |
|---|---|---|
| Printing ink 1 | as per Example 1 | yes |
| Printing ink 2 | as per Example 1 | no |
| Printing ink 3 | as per Example 2 | yes |
| Printing ink 4 | as per Example 2 | no |
| Printing ink 5 | as per Example 3 | yes |
| Printing ink 6 | as per Example 3 | no |
| Printing ink 7 | conventional PU | yes |
| | binder | |
| | (PUR 7313 (BASF)) | |
| Printing ink 8 | conventional PU | no |
| | binder | |
| | (PUR 7313 (BASF)) | |

Adhesion to Substrates

The adhesion of the printing inks of the invention to polar films of polyamide and PET and to an apolar film of PP was measured.

Measurement Method:

The “tesa strength” test method is used to determine the adhesion of a film of printing ink to the print substrate.

Implementation of the Test

The ink diluted to printing viscosity is printed onto the respective film or drawn down using a 6 μm doctor blade. A strip of tesaband (adhesive tape with a width of 19 mm (Article BDF 4104, Beiersdorf AG) is stuck onto the printing ink film, pressed down uniformly and torn off again after 10 seconds. This procedure is repeated 4 times on the same area of the test specimen, in each case using a new strip of tape. Each strip of tape is stuck successively onto a piece of white paper or, in the case of white inks, onto black paper. Testing is carried out immediately following application of the ink.

Evaluation

A visual examination is made of the surface of the test specimen for damage. The score awarded ranges from 1 (very poor) to 5 (very good). Tables 3 and 4 summarize the results of the tests.

TABLE 3
Test results with printing inks containing adhesion promoter

| | PP film | PET film | Polyamide film |
|---|---|---|---|
| | (MB 400) | (Melinex 800) | (Walomid XXL) |
| Printing ink 1 | 5 | 3 | 2 |
| Printing ink 3 | 5 | 3 | 3 |
| Printing ink 5 | 5 | 4 | 1 |
| Printing ink 7 | 5 | 3 | 1 |
| (comparative) | | | |

TABLE 4
Test results with printing inks containing no adhesion promoter

| | PP film | PET film | Polyamide film |
|---|---|---|---|
| | (MB 400) | (Melinex 800) | (Walomid XXL) |
| Printing ink 2 | 5 | 1 | 2 |
| Printing ink 4 | 5 | 1 | 2 |
| Printing ink 6 | 5 | 2 | 1 |
| Printing ink 8 | 1 | 1 | 1 |
| (comparative) | | | |

Production of Composite Materials

Using printing inks 1-8, multilayer materials were produced. The quality of the laminates is determined by measuring the adhesion between two films joined by laminating.

### EXAMPLES 4-10

General Procedure

The ink diluted to printing viscosity is printed onto film 1 as substrate. In parallel, the laminating film (film 2) is coated with an adhesive/hardener mixture (R & H MOR-FREE A 4123/hardener C 88)) so as to give a film thickness of approximately 6 μm. The two films are then pressed to one another so that the printing ink and the adhesive come into contact. After pressing together, the composite films are stored at 60° C. for three days and then the laminate strength is measured. The results of the tests are summarized in table 5.

Description of the Test Method:

Test Method:

| | |
|---|---|
| Measurement and testing apparatus: | Zwick tensile tester |
| | Punching tool (width: 15 mm) |

At least two strips (width: 15 mm) in each case are cut longitudinally and transversely to the film width from the composite material under test. In order to make it easier for the laminate to separate (delamination), the ends of the punched-out strips can be immersed in a suitable solvent (e.g. 2-butanone) until the materials part from one another. Thereafter the specimen is carefully dried. The delaminated ends of the test specimens are clamped into the tensile strength tester. The less extensible film is inserted into the upper jaw. When the machine is started, the end of the specimen should be held at right angles to the direction of tension, thereby ensuring constant tension. The rate of peel is 100 mm/min, the peel angle of the separated films to the unseparated complex 90°.

Evaluation:

The laminate strength is read off as the mean value, and reported in N/15 mm.

TABLE 5
Results for the composites, polyamide film: Walomid XXL, PET film: Melinex 800,
PP film: MB 400

| | Film 1 | Film 2 | | | |
|---|---|---|---|---|---|
| | Print | Laminating | | Adhesion | Laminate strength |
| Example | substrate | film | Printing ink | promoter | (N/15 mm) |
| Example 4 | polyamide | PE | printing ink 1 | yes | 6.2 |
| Example 5 | polyamide | PE | printing ink 2 | no | 4.5 |
| Example 6 | PET | PE | printing ink 1 | yes | 4.7 |
| Example 7 | PET | PE | printing ink 2 | no | 4.5 |
| Example 9 | PP | PE | printing ink 1 | yes | 3.2 |
| Example 10 | PP | PE | printing ink 2 | no | 5.7 |
| Comparative | polyamide | PE | printing ink 7 | yes | <0.5 |
| example 1 | | | | | |
| Comparative | polyamide | PE | printing ink 8 | no | <0.5 |
| example 2 | | | | | |
| Comparative | PP | PE | printing ink 7 | yes | 2.5 |
| example 3 | | | | | |
| Comparative | PP | PE | printing ink 8 | no | <0.5 |
| example 4 | | | | | |

The test results show that the adhesion of the printing inks of the invention even to chemically different film types is significantly improved by the use of the hyperbranched polyesters as compared with conventional binders.

Particularly surprising is the fact that there is no need for adhesion promoters and yet very good results in the production of multilayer materials are still obtained.

The advantages in comparison with the prior art are even more clearly pronounced in the case of the multilayer materials of the invention. With conventional systems, in the case of polar films when the adhesion promoter is omitted, no adhesion at all is obtained. Particularly when using polar films, the multilayer materials of the invention with hyperbranched polyesters exhibit outstanding adhesion.

This result is all the more surprising on account of the fact that the simple adhesive tape tests did not suggest this very good result.

1. A multilayer material for producing packaging, comprising at least
one film 1 of a polymeric material,
one print layer obtainable by printing or coating with a packaging printing ink,
one further film 2,
wherein
the print layer is arranged between the two films, and wherein said packaging printing ink comprises as binder at least one hyperbranched polyester containing functional groups selected from the group consisting of OH, COOH and COOR groups, the acid number of the hyperbranched polyester is 1-200 mg KOH/g, and the OH number is 50-500 mg KOH/g.

2. A multilayer material as claimed in claim 1, wherein the print layer is printed directly onto film 1 or film 2.

3. A multilayer material as claimed in claim 1, wherein film 1 is a multilayer film.

4. A multilayer material as claimed in claim 1, wherein film 1 is a film selected from the group consisting of polyethylene, polypropylene, polystyrene, polyester, and polyamide films.

5. A multilayer material as claimed in claim 4, wherein film 1 is a polar film selected from the group consisting of PET, PEN, and polyamide films.

6. A multilayer material as claimed in claim 1, wherein a further film 2 is a film selected from the group consisting of polymer films, including metallized polymer films, and metal foils.

7. A multilayer material as claimed in claim 6, wherein film 2 is a polyolefin film.

8. A multilayer material as claimed in claim 1, further comprising an odor barrier layer.

9. A multilayer material as claimed in claim 1, further comprising one or more adhesive layers.

10. A multilayer material as claimed in claim 1, further comprising at least one varnish layer as primer or protector.

11. A multilayer material as claimed in claim 10, wherein the varnish layer comprises as binder at least one hyperbranched polyester containing functional groups selected from the group consisting of OH, COOH and COOR groups.

12. A multilayer material as claimed in claim 1, wherein the hyperbranched polyester contains COOH and OH groups.

13. A packaging printing ink for flexographic and/or gravia printing, at least comprising at least one solvent or a mixture of different solvents, at least one colorant, at least one polymeric binder, and, optionally, additives as well, wherein at least one of the polymeric binders is a hyperbranched polyester containing functional groups and the functional groups are selected from the group consisting of OH, COOH and COOR groups, the acid number of the hyperbranched polyester is 1-200 mg KOH/g, and the OH number is 50-500 mg KOH/g.

14. The use of a packaging printing ink as claimed in claim 13 for printing polymer films or metal foils.

15. The use of a packaging printing ink as claimed in claim 13 for producing multilayer materials.

16. A printing varnish at least comprising at least one solvent or a mixture of different solvents, at least one polymeric binder, and, optionally, additives as well, wherein at least one of the polymeric binders is a hyperbranched polyester containing functional groups where the functional groups are selected from the group consisting of OH, COOH and COOR groups, the acid number of the hyperbranched polyester is 1-200 mg KOH/g, and the OH number is 50-500 mg KOH/g.

17. The use of a printing varnish as claimed in claim 16 for priming polymer films or metal foils or as a protective layer.

18. The use of a printing varnish as claimed in claim 16 for producing multilayer materials.
